(19) United States
(12) Patent Application Publication
(10) Pub. No.: US 2022/0056892 A1
(43) Pub. Date: Feb. 24, 2022

(54) PROPULSION MECHANISM

(71) Applicant: Benyamin Akbari Rostami, Vancouver (CA)

(72) Inventor: Benyamin Akbari Rostami, Vancouver (CA)

(21) Appl. No.: 17/000,293

(22) Filed: Aug. 22, 2020

(51) Int. Cl. F03G 3/00

(52) U.S. Cl. CPC F03G 3/00

(57) ABSTRACT

A new propulsion mechanism is disclosed that comprises of at least two arms located opposite to each other, each arm has two axes of rotation at its two ends, and a weight that is slidable on each arm. Corresponding axes of rotation of each arm attach to and detach from each other in a cyclic manner by a set of retaining chassis. The connection of the opposing arms supports their position and stabilizes the motion of the system. Each arm rotates around its own axes and carries its weight according to the pattern and time table shown in (FIG. 1) (FIG. 2). The result of this process creates a force in a specific direction. When the ends of the arms are connected, they will act as a support for a structure that is attached to them. The structure moves in the appropriate direction.

### BACKGROUND OF THE INVENTION

There are many ideas so far about making a device that create the driver force, but none of them have succeeded so far. But this machine with its own mechanism can move in the direction of the designed direction. In each cycle of operation of this device, the whole system travels the length of one arm (FIG. 3), if in some other ideas, the whole system is tried to move together, this is not possible. Some other ideas have tried to move the device based on another support such as friction, air and so on which is also impossible, but this device, the machine moves on its own support, and the position of the supports is constantly changing. In this device, by creating a balance between forces, the support points in the space are stabilized and after the end of the task, each support in each period is transferred to the next position. This device is designed in such a way that its engines mechanism also carries the system to the designated path as long as each arm.

### SUMMARY OF THE INVENTION

The present propulsion mechanism comprises of a set rotating arm that can move a column. The column has a top end and bottom end. The mechanism has at least two rotating arms: A first arm and a second arm. Each arm comprises of a first end and second end, wherein the first end is the first axis of rotation and the second end is the second axis of rotation. Each arm also has a first retaining chassis on the first end and a second retaining chassis on the second end; each retaining chassis of each arm having a rotating mechanism to rotate each arm around each axis of rotation; each retaining chassis of each arm having an attaching mechanism to detachably attach to the corresponding retaining chassis in another arm, whereby the first retaining chassis in the first arm detachably attaches to the first retaining chassis in the second arm; a first weight on the first arm that slides over the first arm and a second weight on the second arm that slides over the second arm. The rotation, attachment and detachment of the first and second arm, as well as a mass of each weight, results in a predefined centrifugal force and thereby a propulsion force is generated to carry a system a predefined path. The propulsion mechanism operates in a cycle, wherein at the beginning of each cycle, each arm extending along the column, the first retaining chassis of the first arm and the first retaining chassis of the second arm are attached to each other at the top end of the column, the second retaining chassis of the first arm and the second retaining chassis of the second arm are not attached to each other at the bottom end of the column, and the first weight and the second weight are at the top end of the column; then in the each rotating mechanism rotates each arm and thereby each weight slides from the first end towards the second end of the arm until the second retaining chassis of the first arm and the second retaining chassis of the second arm come together and attach to each other, while the first retaining chassis of the first arm and the first retaining chassis of the second arm detach, thereby the rotation of each arm generates a propulsion force. A desired propulsion force can be designed by choosing a particular arm length and mass, a predefined weight, and a rotation speed. In one embodiment of the present invention, the column engages with each of the retaining mechanisms through a gear and pinion mechanism, thereby the movement of the attached retaining chassis moves the column. In other embodiments of the present invention, the propulsion mechanism has 4 or 6 or more number of arms with equally spaced angles. In one embodiment of the present invention, the rotating mechanism is a motor, however, other types of rotating mechanism cab be used. In one embodiment of the present invention, the attaching mechanism is an electrically controlled locking or latching system or a magnetic system.

### BRIEF DESCRIPTION OF THE DRAWINGS

FIG. 1 is a schematic diagram showing the movement of mass in a different position (own motion pattern) in one cycle.

FIG. 2 is a time table for an example of one cycle of own motion pattern.

FIG. 3 shows the whole of device with two assembled arms, in front, top, right and isometric views.

FIG. 4 is the detail K on the FIG. 3.

FIG. 5 is the explode of device which showed in FIG. 3.

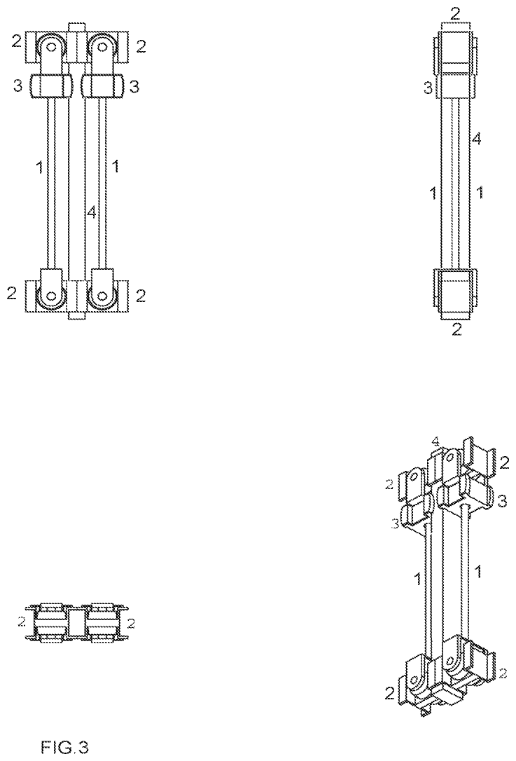

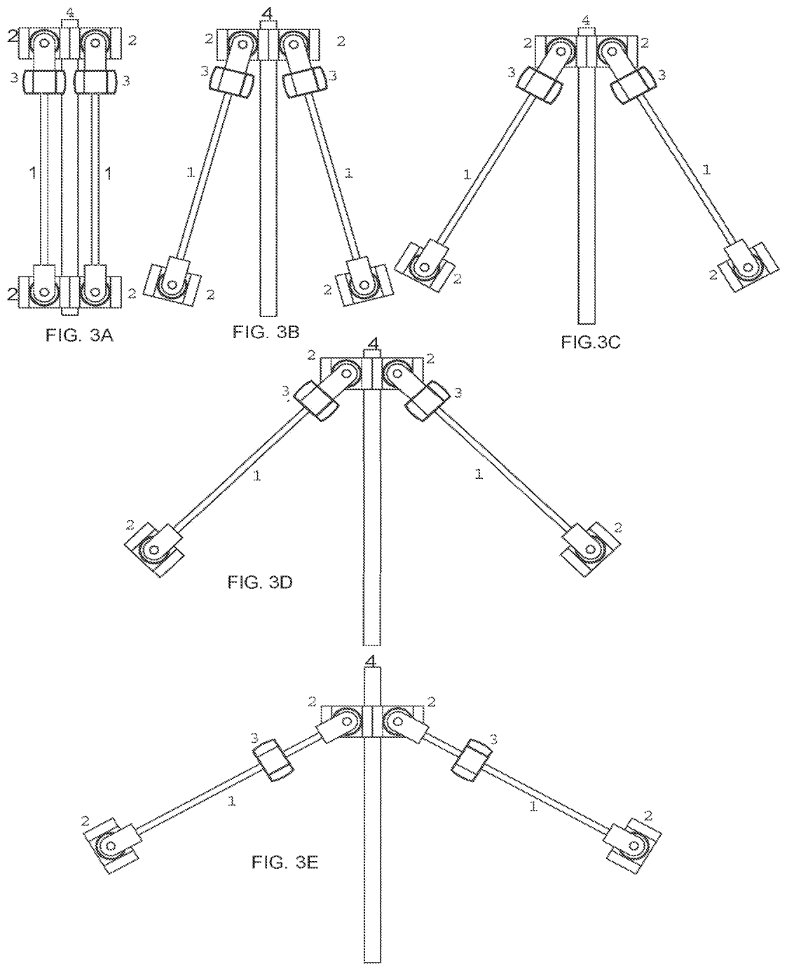

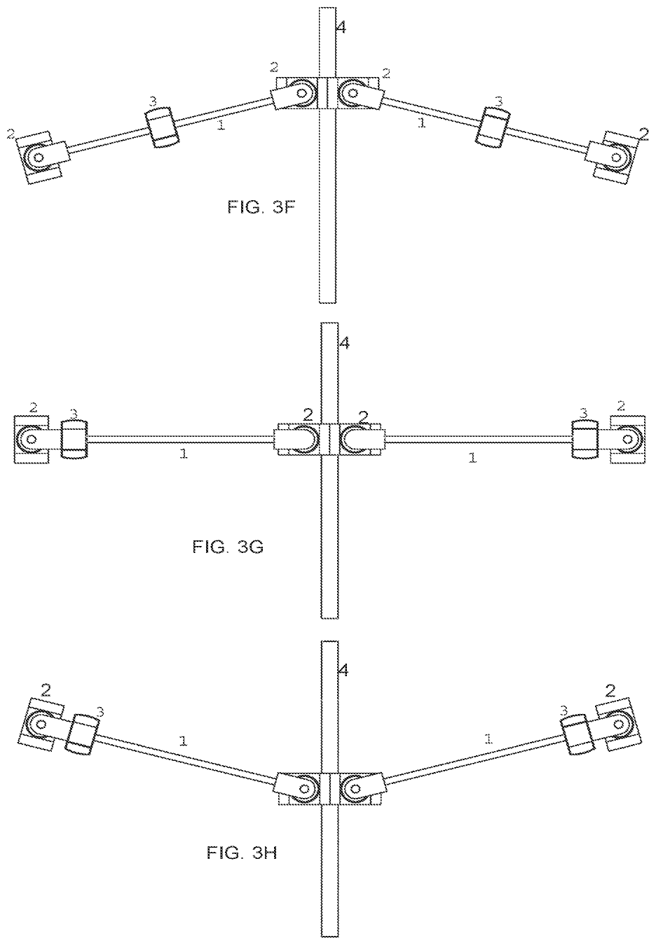

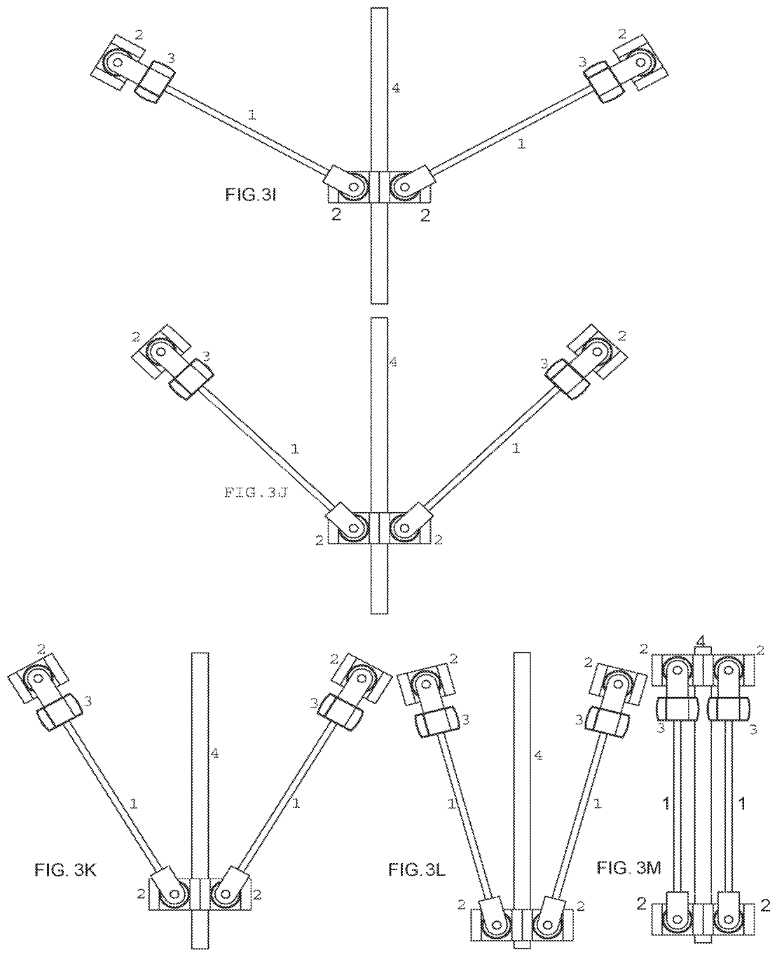

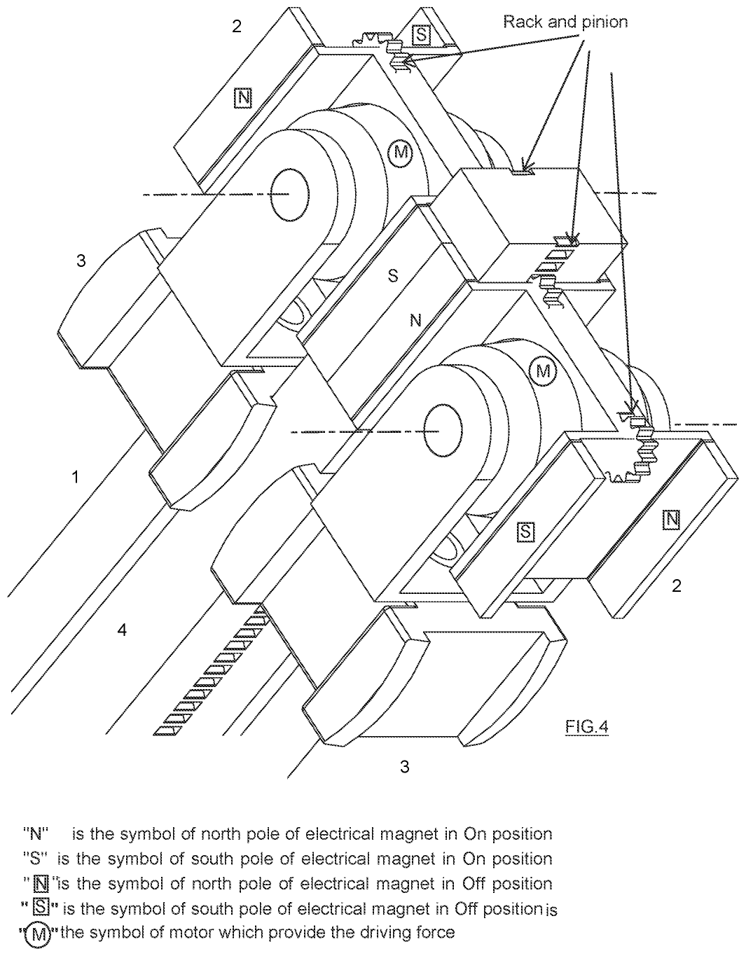

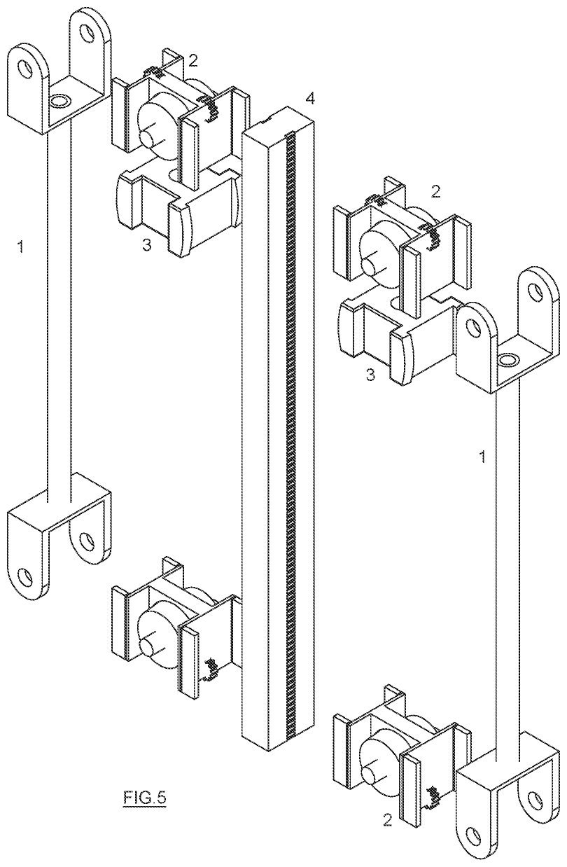

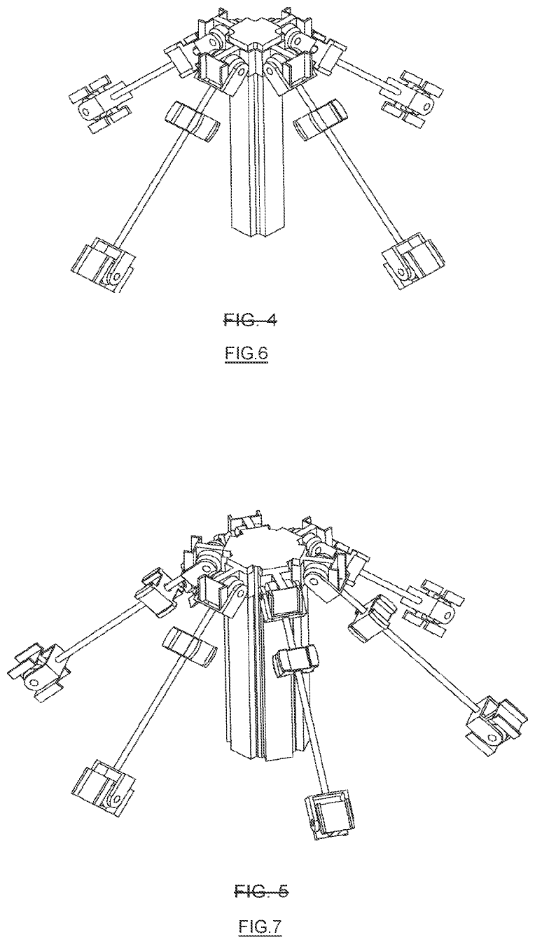

FIG. 3A is showing the device work at time 0.

FIG. 3B is showing the device work at time 1.

FIG. 3C is showing the device work at time 2.

FIG. 3D is showing the device work at time 3.

FIG. 3E is showing the device work at time 4.

FIG. 3F is showing the device work at time 5.

FIG. 3G is showing the device work at time 6.

FIG. 3H is showing the device work at time 7.

FIG. 3I is showing the device work at time 8.

FIG. 3J is showing the device work at time 9.

FIG. 3K is showing the device work at time 10.

FIG. 3L is showing the device work at time 11.

FIG. 3M is showing the device work at time 12.

FIG. 6 shows the assembly of the whole of one set of devices with four arms.

FIG. 7 shows the assembly of the whole of one set of devices with six arms.

### DESCRIPTION OF THE INVENTION

For avoiding to repeat the explication of some words in this invention the following is the meaning of the words used in this invention, because with the movement of some parts of this device their functions change, for example:

Support, when the retaining chassis 2 attached and reached at location (FIG. 3G) they have the duty of a support.

Own motion, the movement of the weights is unique because they move part of the path of a circle in opposite directions to each other and in accordance with their pattern, and in the next cycle their rotation axes change.
Weight 3: means the piece that rotate by arm 1 and used such a mass in formula.
Own motion: means the movement of the weights 3 by the arms 1 in opposite directions to each other in a part of the path of a circle according to the pattern (FIG. 1).
Support means: the retaining chassis 2 when attach to each other and reached at the position of (FIG. 3G), now they used as a support for movement the other parts of the device, no when they are detached.
Structural means the column 4 when the retaining chassis reached to the stable position (FIG. 3G), now the column 4 continues the rest of the way and moves with it whole of the device as a structure.

The following are the main reasons for the success of this device which cause to generates a propulsion mechanism that the device moves according to that.
The movement of the weights 3 as a mass according to the pattern (FIG. 1).
Changing the axes of the arms' rotation regularly.
Using the retaining chassis 2 as a support for structure's movement.
   Movement of the weights 3 as amass according to this pattern (FIG. 1) cause to generate the force in the same direction as the arms' rotation, because in this pattern the weights 3 go through part of a circle, not the path of a complete circle.
   Changing the rotation axis cause the weights 3 to always repeat their movement in the same path of a part of the circle according to the pattern (FIG. 1).
   Because the directions of the weights' rotation are opposite to each other, the mass of the weights 3 and the velocity of the rotations of them are the same also, and because the radius of the rotations is the same in terms of equal length of the arms 1, the forces created when the weights 3 are in the position as same as in (FIG. 3G) have equal amount and opposite vector. Now the retaining chassis 2 are stretched through the arms 1 due to the opposite direction of the forces. the retaining chassis 2 are be stable in their positions and act as a stable support for movement of whole of the structure.
   The point here is because the movement of the connected retaining chassis 2 as supports and the column 4 are the same path and opposite to each other, there is always movement of the structure from first end of the column 4 to the second end of the column 4, but as long as the retaining chassis 2 reaches a stable condition (FIG. 3G), the column 4 will starts moving to continue the rest of the path.

Requirements for making this device are:
Providing the necessary driving force for rotating the arms 1.
Providing a means for attaching and detaching the retaining chassis 2.
Providing a means for movement the column 4.

There are several usable options for these requirements which according to the application of the device are selected, and there are no restrictions on the choice of equipment and the important points in this case are the requirements. The following are examples of possible cases for these requirements, but they are not limited to these.
Electrical motors, mechanical engines and so on for providing the necessary driving force for rotating the arms 1.
Electrical magnets with switching on/off, mechanical lock and latch, small servo motors for locking and latching and so on for attaching and detaching the retaining chassis 2.
Rack and pinon, pully and belt, gear and chain and so on for movement the column 4.

In order to make the present device first making the arms 1 (FIG. 3) at least two arms it has two axes at its ends that in each period one of them is fixed and the other one rotates around that. The length of these arms is design based on the application of the device. In proportion to the design of the device, the application of rotational force to the two axes of the arms should be considered. At both ends of the arms, the location of the retaining chassis 2 (FIG. 3) should be considered these chassis 2 are responsible for holding the other axle at the specific times. One of the design features for this device is that the rotating motors of the arms can be installed in these chassis 2. The weights 3 (FIG. 3) of each arm will be proportional to the design calculations that are located between the two ends of the arm slide easily between the two ends of the arm. The structural column 4 (FIG. 3) is connected to the support points and slides towards the design path and pushes itself forward by changing the support points. There is no limit to the number of arms and the number is calculated and designed based on the application of the device, but the only important point is that the angles between all the arms should be the same, like examples (FIG. 6) (FIG. 7). Figures (FIG. 3A) to (FIG. 3M) show a process cycle of the device with two arms. At time zero (FIG. 3A), the two ends of the arms 1 connected and the weight 3 is at the closest distance from the center of the rotation, which occurs in the next step. And the structural column 4 is located in such a way that the support points 2 are located between its length. In the time first, the proper ends of arms 1 are released and reached the right angle with the speed of rotation of the arms. And the weights 3 are still in the distance before the center of the rotation. And the structural column 4 is still in the last position. And the centers of the rotation of these are the other ends of the arms 1, to which the weight 3 are closer at this time, and for going to the next step the arms start to rotate around their first axis by the rotational force of the motors. In the time second (FIG. 3B), the arms 1 have reached an angle proportion to the rotational speed of the arms and weights 3 and structural column 4 are still the same last position. In the time third (FIG. 3C), the arms 1 have reached an angle proportion to the rotational speed of the arms and weights 3 and structural column 4 are still the same last position. In the time third (FIG. 3D), the arms 1 have reached an angle proportion to the rotational speed of the arms and weights 3 are released and start to moved away from the rotating axis to a specified size in proportion to the design speed and the structural begins its movement towards to the other end of the column 4 by supporting the junction 2 of the other two ends of arm that are fixed in this rotating cycle. In the time forth (FIG. 3E), the arms 1 have reached an angle proportion to the rotational speed of the arms and weights 3 have made their way to the other end of the arms more and the structural still goes further than before. In the time fifth (FIG. 3F), the arms 1 have reached an angle proportion to the rotational speed of the arms and weights 3 have made their way to the other end of the arms more and structural still goes further than before. In the time sixth (FIG. 3G) the arms 1 have reached an angle proportion to the rotational speed of the arms, based on the assumptions of this example and in proportion to the time division the arms rotate a quarter of a circle and weights 3 have traveled their way to the other end of the arms and at this moment they are at their farthest distance from the center of the epoch and structural almost reached in the middle of the column 4, in this moment because of the due to the tensile force created in the arms, the support gets a stable position and the column 4 moves the rest of the path until the support reached the end of the column 4. The rest of the path (FIGS. 3H-3M) the arms still continue to own_motion and carry the weights, at this time, the arms have completed a cycle of rotation [,] now the rotating ends of the arms are connected to each other and the other ends, which had been connected so for, and the arms revolved around them are released and be ready to turn, at this point, the structural is fully on its way to a cycle of rotations. Of course, the weights are at the closest distance from the other end. And these points are the farthest distances of the weights from the center of the rotation, which produces the maximum centrifugal force. And the direction of the result of these forces will be in accordance with the design of the device and the amount of force from each arm is equal to centripetal force, F, defined by

$$F = \frac{m {v}^{2}}{r}$$

where m is the mass of the rotating system which here the weights 3 are such a mass, r is a radial distance which here the distance between the weights 3 and the rotation axis of the arms 1 are such as a redial distance, and velocity v=ωr, where ω is the angular velocity, which here the speed of the arms' rotation that provided by the motors is such a velocity. All the system parameters need to be designed to provide the desired force. System components, including arm length [r] (rotation radius), mass of the weights [m] and rotational speed of the arm [v] influence the force. Each time the arms rotate, the result of the forces resulting from this rotation will be in the direction of the designed direction which corresponds to the direction of rotation of the arms, which according to the effective items in equation above such as the speed of arms rotation [v], the length of the arms [r] and the mass of the weights [m], it should be designed in such a way that the resulting force moves the device and structure in the desired direction.

The propulsion mechanism works according to the following steps and obtains all its required force from the force resulting from the rotation of the weights 3 as a mass according to the pattern (FIG. 1), of course, the arms 1 carrying the weights 3 are rotated by the motors.
Initially, the whole device is connected to the column 4 by the retaining chassis 2 according to the (FIG. 3), and the column 4 is the only connection point of the device from the starting point of the movement.
The force required to rotate the arms 1 are provided by the motors.
The arms 1 rotate around their first axes.
By the arms 1, the weights 3 rotate as a mass according to the pattern (FIG. 1)
The retaining chassis 2 are pulled when the weights 3 reach in the position (FIG. 3G) due to the forces resulting from the rotation of the weights 3 are equal and opposite to each other, accordingly, the retaining chassis 2 are stabled and act as a support for the movement of the device.
Simultaneous, the weights 3 are continued the rest of their own motion by the arms 1 and the column 4 moves by the operation of the rack and pinion and separated from the resting location.
The first cycle is completed when the other retaining chassis 2 attached to each other and the retaining chassis 2 which had attached to each other during the first cycle be detached and prepared to rotate.

At this time the rotation's axes changed and the next cycle starts and this process continues.

By starting the movement of the device with the force obtained from the first rotation, the device is separated from the starting platform and at the same time, the cycle of the second rotation continues. And it is here that with each rotation of the arms, while producing the necessary force for movement, the machine also travels the length of its arms. In addition, due to the placement of the axes of rotation and their directions and considering the equality of the forces at all moments of the junction of the arms will be a fulcrum. The junction of the arms is also the junction of the structure column which the structure and its Pawel slide form this connection to the designed path of the device.

This is the demonstration of how make a simple version of this machine. This machine is consists of a number of uniform assembled arms (FIG. 3), so by completing one assembled arm (FIG. 3), the rest of the assembled arms (FIG. 3) will be made in the same way. Install two chassis holds (2) at both ends of each arm (1) so that the axis of rotation of each one corresponds to the axis of rotation of each end of the arm (1). Then install the corresponding weight (3) on each arm at the closest distance from the axis of the first rotation. After completing the number of designed arms, connect them by chassis holds (2) from the end of the first rotations of the arm. But the other end of the arms should be free and ready for rotation. Now put the main column or pillar (4) in place and connect it to the connected chassis holds (2).

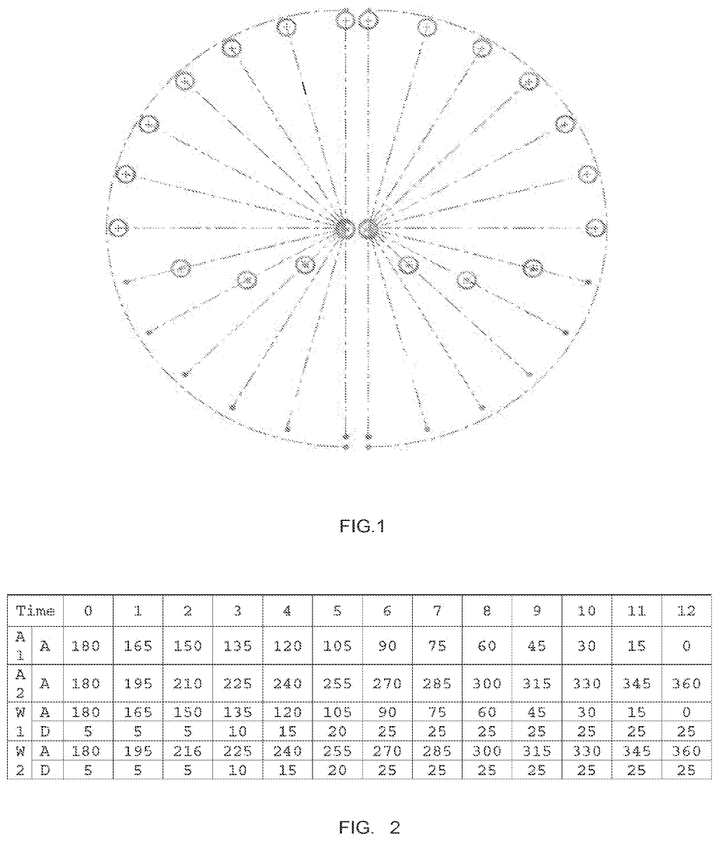

1: A propulsion mechanism to provide a stable structure as a support for its own motion comprising:
a column having a top end and bottom end;
a first arm and a second arm;
each arm comprising:
a first end and second end, wherein the first end is the first axis of rotation and the second end is the second axis of rotation;
a first retaining chassis on the first end and a second retaining chassis on the second end;
each retaining chassis of each arm having a rotating mechanism to rotate each arm around each axis of rotation;
each retaining chassis of each arm having an attaching mechanism to detachably attach to the corresponding retaining chassis in another arm, whereby the first retaining chassis in the first arm detachably attaches to the first retaining chassis in the second arm;
a first weight on the first arm that slides over the first arm and a second weight on the second arm that slides over the second arm;
each arm rotates around its own axes according to the pattern shown in (FIG. 1) and the time table shown in (FIG. 2),
whereby the propulsion mechanism operates in a cycle, wherein at the beginning of each cycle,
each arm extending along the column, the first retaining chassis of the first arm and the first retaining chassis of the second arm are attached to each other at the top end of the column, the second retaining chassis of the first arm and the second retaining chassis of the second arm are not attached to each other at the bottom end of the column, and the first weight and the second weight are at the top end of the column;
then in the each rotating mechanism rotates each arm and thereby each weight slides from the first end towards the second end of the arm until the second retaining chassis of the first arm and the second retaining chassis of the second arm come together and attach to each other, while the first retaining chassis of the first arm and the first retaining chassis of the second arm detach, thereby the rotation of each arm generates a propulsion force,
whereby the propulsions system acts as a stable structure that acts as a support for its own motion.

2-6. (canceled)

7: The propulsion mechanism of claim 1, wherein the rotation of these weights as a mass according to the pattern (FIG. 1) around the first rotation's axis cause that the result of the forces resulting from this cycle of rotation to always be in the same direction and similar to the rotation of the arms.

8: The propulsion mechanism of claim 1 and claim 2, wherein the rotation axis will be changed after each cycle of rotating according to pattern (FIG. 1) and the next cycles of rotating are the same of the first cycle and the repetition of the cycles and changing the rotation's axis caused the created forces to always be in the same direction.

9: The propulsion mechanism of claim 1, wherein the tensile force which created in the arms and the retaining chassis are equal and opposite each other (FIG. 3G) cause the retaining chassis be stable and they act as a support for movement of the rest of the structure.

10: The propulsion mechanism of claim 1, claim 2, claim 3 and claim 4, wherein the result of the forces from each cycle of rotation has one direction and because this cycle is repeated in terms of changing the axis of rotation regularly, the propulsion mechanism moves the device by using this force and the stabilization of the retaining chassis which act as a support.

11: The propulsion mechanism of claim 1, claim 2 and claim 3, wherein each cycle of rotation be completed and the rotation's axis was changed, because the new rotation's axis has already moved as long as length of one arm that means the whole of the device has moved as long as length of one arm.
